(19) United States
(12) Patent Application Publication
(10) Pub. No.: US 2011/0212800 A1
(43) Pub. Date: Sep. 1, 2011

(54) Pulley

(76) Inventors: Heinz Breunig, Aschaffenburg (DE); Thomas Friedrich, Hausen (DE); Alfred Schott, Schwanfeld (DE)

(21) Appl. No.: 13/056,059

(22) PCT Filed: Jul. 27, 2009
(86) PCT No.: PCT/EP09/05421

§ 371 Date: Apr. 29, 2011

(30) Foreign Application Priority Data
Jul. 28, 2008 (DE) 10 2008 035 204.7

(51) Int. Cl. F16H 55/36

(52) U.S. Cl. 474/166

(57) ABSTRACT

A pulley comprises a hollow-cylinder support element rotatably supporting a hollow body about a rotational axis and having first and second dome-shaped axial ends. An attachment element has a central axis extending in an axial direction and a complementary dome-shaped axial end abutting the first dome-shaped axial end of the support element. A rod extends within the support element and has a first axial end fixedly connectable with the complementary dome-shaped axial end of the attachment element. A fixing element is connected with a second axial end of the rod and has a complementary dome-shaped axial end abutting the second dome-shaped axial end of the support element. The rotational axis of the hollow body is angularly pivotable relative to the central axis at the fixing element. One of the first and second dome-shaped axial ends of the support element is concave and the other is convex.

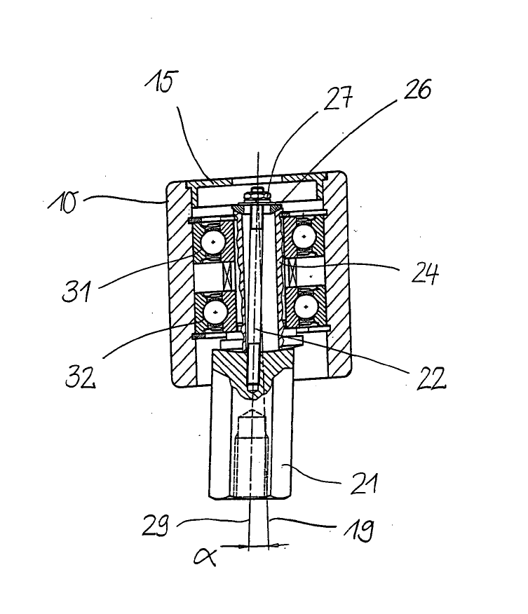

The invention relates to a pulley.

For example, pulleys are known in the prior art, whose rotatably-borne outer surface serves, e.g., to deflect or guide an endless belt. It is a goal to minimize the wear on the belt and pulley as much as possible.

Therefore, it is an object of the invention to provide an improved pulley, with which long usage durations are achievable with simple and thus cost-effective constructions of the pulley.

This object is achieved by the subject matter of claim 1. Advantageous embodiments are described in the dependent claims.

According to claim 1, a pulley comprises the following features:
A hollow body, whose outer surface forms the rolling contact surface of the pulley,
a hollow cylindrical support element, with which the hollow body is rotatably connected,
an attachment element axially extending along a main axis, with which the support element is fixedly connectable,
the end sides of the attachment element and the support element provided to abut each other are formed in a dome-shaped manner so as to correspond to each other, so that an inclination angle of the rotational axis of the hollow body is adjustable relative to the main axis of the attachment element,
a rod that is attachable to the attachment element approximately in the middle of the dome-shaped end side of the attachment element and that extends through the hollow cavity of the support element, wherein the other axial end of the support element is fixable with a fixing means attachable to the rod at a selected inclination angle relative to the attachment element,
the other end side of the support element is also formed in a dome-shaped manner and the fixing means, or an intervening element disposable between the fixing means and the support element, is formed so as to correspond to the dome-shaped end side, and
one of the end sides of the support element is formed concave and the other is formed convex.

By forming the outer surface of the hollow body that forms the rolling contact surface so as to be, so-to-speak, angularly-adjustable relative to the attachment element, a uniform loading of the belt and the pulley over a long usage duration can be advantageously achieved by a suitable angular adjustment, wherein a simple and thus relatively cost-effective producible angular adjustment possibility for the pulley is advantageously provided by the dome-shaped construction of the attachment element and the support element. Because a bearing between the hollow body and the support element is thus required to have no or only a very small angular adjustability—the actual angular adjustability is realized between the support element and the attachment element—cost-effective roller bearings, e.g., radial deep groove ball bearings, can thus be utilized in an advantageous manner. In other embodiments, the inventive pulley can also be used, of course, as an idler pulley outside of a belt system and/or as a support pulley or a guide pulley.

Further advantages, features and details of the invention are derivable from the exemplary embodiment of the invention described in the following with the assistance of the FIGURE.

The FIGURE shows a longitudinal-section through a pulley serving as an exemplary embodiment of the invention. The pulley comprises a hollow-cylinder-like hollow body 10; for example, a belt is guided on the outer surface of the hollow body and the belt is associated with a letter sorting and/or distributing system. The pulley further comprises a cylinder-like attachment element 21 extending along the main axis 29 and having an outer surface formed in a hexagonal-like manner, wherein a threaded bore is provided on the lower end surface of the attachment element 21 in the axial direction; the attachment element is fixedly connectable with its installation environment via the threaded bore.

An inner portion of the top end surface of the attachment element 21 is formed so as to be inwardly bulged in a dome-shaped manner. A bolt 22, which is formed with a thread at least on its longitudinal end, is attached with the attachment element 21 approximately in the middle of the dome-shaped end side; the bolt 22 extends in the direction of the main axis 29. The bolt 22 is fixedly screwed into the attachment element 21 and is further prevented from loosening by suitable means, such as by an adhesively-bonded connection. In other embodiments, the bolt 22 and the attachment element 21 can, of course, also be connected with each other in another manner, but in principle they can also be formed together in a one-piece and materially-integral manner.

The bolt 22 is surrounded by a hollow cylinder-like support element 24; the lower axial end of the support element 24 is formed with a flange-like projection; the lower end side of the projection is axially outwardly bulged in a dome-shaped manner so as to correspondingly match the dome-shaped end side of the attachment element 21. The upper axial end of the support element 24 is formed with an inwardly-bulged, dome-shaped end side so that, after setting an intervening disk 26 thereon, which disk 26 is formed with an outwardly-bulged, dome-shaped end side that corresponds to the support element 24, the support element 24 is fixable at a predeterminable inclination of a rotational axis 19 of the pulley relative to the main axis 29 of the attachment element 21 by a nut 27 that can be screwed onto the top thread of the bolt 22. The intervening disk 26 is obtainable, e.g., as a standard component.

The two dome-shaped portions are formed such that their radii have a common middle point disposed on the main axis 29 of the attachment element 21. The axial length of the bolt 22 and the support element 24, as well as the diameter of the bolt 22 and the inner diameter of the support element 24, are selected such that the rotational axis 19 of the hollow body 10 is angularly adjustable about an inclination angle a in the range of about +/−3° relative to the main axis 29 of the attachment element 21.

The hollow body 10 of the pulley is connected with the support element 24 via two radial deep groove ball bearings 31 and 32. The outer surfaces of the two outer rings of the ball bearings 31 and 32 abut on the inner surface of the hollow body 10. The upper end side of the outer ring of the upper ball bearing 31 and the lower end side of the outer ring of the lower ball bearing 21 are each secured in the hollow body 10 in the axial direction using a retaining ring that is snap-fit into a corresponding groove on the inner surface of the hollow body 10. The inner surfaces of the inner rings of the two ball bearings 31 and 32 abut on the outer surface of the support element 24. The lower end side of the inner ring of the lower ball bearing 32 abuts on the extension forming the support element 24 and the upper end side of the inner ring of the upper ball bearing 21 is axially secured with a retaining ring that is inserted into a groove formed in a corresponding manner on the outer surface of the support element 24. Further, a spring element 35 is disposed between the two inner rings of the two ball bearings 31 and 32 and presses the two inner rings apart in the axial direction, whereby an embodiment of the bearing is advantageously achieved that is free of play. The ball bearings 31 and 32 comprise sealing gaskets disposed between their outer and inner rings in a known manner for sealing a space containing the balls, wherein the balls are disposed in a cage so as to be guided.

Furthermore, the upper portion of the hollow body 10 is closable by a cover 15, wherein the cover 15 is formed, in turn, with a likewise closable opening, via which the nut 27 is accessible. In one embodiment, the pulley can be formed in a corrosion-resistant manner by using stainless steel materials.

In other embodiments, other types of roller bearings than ball bearings can naturally be used; for example, it is also possible to form the nut and intervening disk in a one-piece manner, to attach the bearing in another manner and/or to also form at least parts of the bearing in a one-piece manner with other elements.

1.-7. (canceled)

8. A pulley comprising:
a hollow body having a cylindrical outer surface that defines a rolling contact surface,
a hollow cylinder support element rotatably supporting the hollow body about a rotational axis,
an attachment element axially extending along a main central axis and being fixedly connectable with the support element, wherein an axial end of the attachment element and a facing axial end of the support element abut each other and have complementary dome-shaped surfaces configured such that the rotational axis of the hollow body is angularly adjustable relative to the main central axis of the attachment element within a range of inclination angles,
a rod attached to the attachment element approximately in the middle of the dome-shaped axial end side of the attachment element and extending through a hollow cavity of the support element, wherein an opposite axial end of the support element is fixedly connectable to the rod at a selected inclination angle relative to the attachment element,
wherein an opposite axial end of the support element also has a dome-shaped surface facing a complementary dome-shaped surface formed on one of a fixing means and an intervening element disposed between the fixing means and the support element and
wherein one of the axial ends of the support element is concave and the other axial end of the support element is convex.

9. A pulley according to claim 8, wherein at least one of (i) a length of the rod and the support element and (ii) an outer diameter of the rod and an inner diameter of the hollow cylindrical support element is selected such that the inclination angle is adjustable between +/−3° relative to the main central axis of the attachment element.

10. A pulley according to claim 9, wherein the dome-shaped surfaces are formed such that their radii have a common middle point disposed on the main central axis of the attachment element.

11. A pulley according to claim 10, further comprising at least one roller bearing rotatably supporting the hollow body on the support element.

12. A pulley according to claim 11, wherein the at least one roller bearing comprises two radial deep groove ball bearings disposed between the hollow body and the support element.

13. A pulley according to claim 12, further comprising a spring disposed between respective inner rings of the two roller bearings, the spring pressing apart the inner rings in the axial direction.

14. A pulley according to claim 13, further comprising at least one retaining ring axially securing at least one of an outer ring or the inner ring of at least one roller bearing, the retaining ring being inserted into a corresponding groove formed in one of (i) an inner surface of the hollow body and (ii) an outer surface of the support element.

15. A pulley according to claim 8, wherein the dome-shaped surfaces are formed such that their radii have a common middle point disposed on the main central axis of the attachment element.

16. A pulley according to claim 8, further comprising at least one roller bearing rotatably supporting the hollow body on the support element.

17. A pulley according to claim 16, wherein the at least one roller bearing comprises two radial deep groove ball bearings disposed between the hollow body and the support element.

18. A pulley according to claim 17, further comprising a spring disposed between respective inner rings of the two roller bearings, the spring pressing apart the inner rings in the axial direction.

19. A pulley according to claim 18, further comprising at least one retaining ring axially securing at least one of an outer ring or the inner ring of at least one roller bearing, the retaining ring being inserted into a corresponding groove formed in one of (i) an inner surface of the hollow body and (ii) an outer surface of the support element.

20. A pulley comprising:
a hollow body having a cylindrical outer surface and a rotational axis,
a hollow cylinder support element rotatably supporting the hollow body about the rotational axis and having first and second axial ends that are each dome-shaped,
an attachment element having a central axis extending in an axial direction and a complementary dome-shaped axial end abutting the first dome-shaped axial end of the support element,
a rod extending within a hollow interior of the support element and having a first axial end fixedly connectable with the complementary dome-shaped axial end of the attachment element,
a fixing element connected to a second axial end of the rod and having a complementary dome-shaped axial end abutting the second dome-shaped axial end of the support element,
wherein the rotational axis of the hollow body is angularly pivotable relative to the central axis of the attachment element at the fixing element, and
wherein one of the first and second dome-shaped axial ends of the support element is concave and the other is convex.

21. A pulley according to claim 20, wherein the rotational axis of the hollow body is angularly pivotable at the fixing element within a range of inclination angles between plus or minus 3° relative to the central axis of the attachment element.

22. A pulley according to claim 21, wherein the first dome-shaped axial end of the support element and the complementary dome-shaped axial end of the attachment element have a common middle point and the rod is fixedly attached at the middle point of the attachment element.

23. A pulley according to claim 22, further comprising at least one roller bearing rotatably supporting the hollow body about the support element.

24. A pulley according to claim 23, wherein the at least one roller bearing comprises a deep groove ball bearing.

25. A pulley according to claim 22, further comprising:
at least two radial deep groove ball bearings rotatably supporting the hollow body about the support element, each having an inner ring, and
a spring disposed between respective inner rings of the two radial deep groove ball bearings, the spring urging the inner rings apart in the axial direction.

26. A pulley according to claim 25, further comprising at least one snap-ring retaining at least one of the radial deep groove ball bearings in the axial direction.

27. A pulley according to claim 26, wherein the at least one snap-ring is snap-fit in a groove defined in one of the hollow body and the support element.
